(19) United States
(12) Patent Application Publication
(10) Pub. No.: US 2009/0012724 A1
(43) Pub. Date: Jan. 8, 2009

(54) METHOD AND APPARATUS FOR THE DETERMINATION OF A STRAIN FOR A WIND ENERGY PLANT

(75) Inventors: Eberhard Voss, Jornstorf (DE); Gunnar Schmidt, Frankenbostel (DE); Matthias Thulke, Berlin (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/872,857

(22) Filed: Oct. 16, 2007

(30) Foreign Application Priority Data
Jul. 6, 2007 (DE) 10 2007 031 969.1

(51) Int. Cl. F03D 11/00; G06F 19/00

(52) U.S. Cl. 702/34; 702/42

(57) ABSTRACT

A method for the determination of a strain of a wind energy plant (30), with the following steps: presetting an assignment code, which assigns a characteristic value (K) for the strain of the wind energy plant to each pair of variates of a value for a wind velocity and a value for an acceleration of a component of the wind energy plant, determining a value (v′), which represents a measured wind velocity v, determining a value (a′), which represents a measured acceleration a of a component of the wind energy plant, applying the assignment code to the pair, of variates of the value (v′) for the measured wind velocity v and the value (a′) for the measured acceleration a in order to determine the characteristic value (K) for the strain.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method and an apparatus for the determination of a strain of a wind energy plant.

Wind energy plants are exposed to great mechanical strains in the operation, which can lead to an immediate destruction of a component of the wind energy plant or to a long-term damage of components through material fatigue. In order to avoid such overloads, it has to be taken care in the operation of the plants that the rated strains of the components are observed. Basis for this is an accurate knowledge of the strains of the individual components actually occurring in the operation.

In the most simple case, the occurring strains can be acquired by measuring a wind velocity. In order to avoid any damage of the wind energy plant, a cut-off wind velocity can be defined, at which suitable protection measures, like stopping down the wind energy plant for instance, are performed. However, in this procedure it is matter of a relatively rough estimate of the actually occurring strains, which can only conditionally take into account the actual conditions of an individual wind energy plant.

In order to get a more accurate idea of the actually occurring strains, it is known to perform an immediate measurement of the strain of individual components. For this purpose, wire strain gauges can be inserted into the tower or the rotor blades of a wind energy plant, which can acquire a deformation of the respective components. These individual measurement data of the actually occurring strain can be used in a variety of ways, for instance in order to check the proper dimensioning of individual components of the wind energy plant and to set maintenance intervals adapted to the actually occurring strains. Moreover, the operation duration and the “aggressivity” of the operation management can be selected depending on the strain. For instance, when the measured strains remain below the values taken as a basis in the dimensioning of the wind energy plant, the lifespan can be prolonged and/or a materials conserving operation management can be modified in favour of a higher energy yield. However, the immediate measurement of the occurring strains is very sumptuous and difficult for longer periods of time in particular, among others because the used wire strain gauges lack the required long-term stability.

As an alternative to an immediate measurement of the strains, a method for measurement and analysis of strains of a wind energy plant is known from EP 1 674 724 A2, the entire contents of which is incorporated herein by reference. In the known method, accelerations of the tower head are measured with the aid of acceleration sensors, which are fixed on the basis plate of a nacelle. The measured acceleration data are converted into movement data of the tower head, on the basis of which a determination of the occurred strains takes place. From this, it can be inferred to a damage or fatigue of the assembly parts exposed to the detected strains.

Based on this, it is the objective of the present invention to indicate a method and an apparatus for the determination of a strain of a wind energy plant, which permit a more accurate determination of the occurring strains with simple means.

### BRIEF SUMMARY OF THE INVENTION

The method serves for the determination of a strain of a wind energy plant and has the following steps: presetting an assignment code, which assigns a characteristic value for the strain of the wind energy plant to each pair of variates of a value for a wind velocity and a value for an acceleration of a component of the wind energy plant, determining a value which represents a measured wind velocity v, determining a value which represents a measured acceleration a of a component of the wind energy plant, applying the assignment code to the pair of variates of the value for the measured wind velocity v and the value for the measured acceleration a in order to determine the characteristic value for the strain.

The invention is based on the finding that a determination of the strain of a wind energy plant only as a result of measured acceleration values means a too strong simplification of the complicated mechanical and aerodynamical conditions of a wind energy plant. An unambiguous assignment of a strain to a certain acceleration value is not possible in general. Therefore, in addition to the measurement of an acceleration a measurement of a wind velocity is also performed, and both measured variables take part in the calculation of the characteristic value for a strain of the wind energy plant. In this, the characteristic value may be related to a certain component of the wind energy plant, for instance to the tower of the wind energy plant, a rotor blade, the drive train, the nacelle or the foundation of the wind energy plant. By taking into account a measured acceleration and a measured wind velocity, a significantly more accurate determination of the strain is made possible. The expenditure for this is small, because a measurement of an acceleration is simple and possible without further ado, whereas a measurement of the wind velocity takes place for the control of the wind energy plant anyway.

The determination of the value representing a measured wind velocity v and that of the value representing a measured acceleration a of a component of the wind energy plant can take place in an arbitrary manner, by the generation of a weighed average value of an amount of the respective measured variable, for instance. Other statistical analysis methods can be also applied to the measured variable, or different statistical characteristic values of a measured variable can be combined with each other, in order to obtain the representing values. Through a statistical analysis of the measured variables, representing values can be established, which have a high explanatory power for the determination of the actually occurring strains.

In one embodiment, the value which represents the measured wind velocity v and/or the value which represents the measured acceleration a, is established by generating an average value of the respective measured variable about a preset time interval.

In one embodiment, the value which represents the measured wind velocity v and/or the value which represents the respective measured acceleration a is established by calculating a standard deviation of the respective measured variable about a preset time interval.

In both of the last-mentioned embodiments, the time interval can have a duration of 10 minutes, for instance, in order to obtain a sufficient resolution in time.

In one embodiment, for the average value generation and/or for the calculation of the standard deviation of the measured wind velocity v, a longer or shorter time interval is preset than for the average value generation or for the calculation, respectively, of the standard deviation of the measured acceleration a. By doing so, both measured variables can be taken into account each with a concerted resolution in time.

According to one embodiment, the measurement of the acceleration a takes place with one or more acceleration sensors, which are arranged in the region of the tower head of the wind energy plant. Through this, a movement of the tower head can be acquired, wherein a separate acceleration sensor can be provided for each movement direction.

In one embodiment, in the establishment of the value which represents an acceleration a, it is averaged about different space directions of the acceleration. Alternatively, a separate analysis for individual space directions may also be performed, in order to be able to analyse the strains depending on the direction. However, through the averaging about different space directions, the analysis can be simplified.

According to one embodiment, an acceleration sensor measures a torsional acceleration in the region of the tower head of the wind energy plant. Through this, a torsional movement or oscillation, respectively, of the tower of the wind energy plant can be measured in a simple way

According to one embodiment, the characteristic value is a numerical value which quantitatively indicates the strain of the component of the wind energy plant. A quantitative determination of the strain permits a particularly differentiated analysis.

According to one embodiment, the characteristic value takes on only two different values, wherein a first value indicates a permissible strain and a second value a not permissible strain of the component of the wind energy plant. In this case, the analysis is particularly simple, and the characteristic value indicates immediately an overload of the respective component of the wind energy plant.

In one embodiment, an analysis of the established characteristic values takes place about long periods of time, in order to detect a material fatigue. In particular in combination with a quantitative characteristic value for the strain, significant data about the material fatigue can be obtained. A damage or an imminent failure of the respective component can be recognised at an early point in time through this, and possibly repaired or avoided, respectively, in a simple way.

According to one embodiment, an established characteristic value is analysed in the operation of the wind energy plant, in order to preset a desired value for the operation of the wind energy plant. The control or regulation, respectively, of the wind energy plant takes place depending on the established strain in this case. For instance, presetting a cut-off speed can be supplemented or replaced by presetting a maximum strain. The efficiency of the operation of the wind energy plant can be increased through this. With the preset desired value it can be matter of a power, a generator rotational speed or a torque, for instance.

In one embodiment, the preset assignment code is established with the aid of a computer simulation, which takes into account the mechanical and aerodynamical properties of the wind energy plant. In principle, the assignment of a strain to a pair of variates which is based on a measured wind velocity v and a measured acceleration a can take place in an arbitrary manner, on the basis of empirical values, for instance. However, it is also possible to examine different operating states and boundary conditions in a computer simulation, and to calculate the occurring strains depending on the later measured values for the wind velocity v and the acceleration a. With the aid of such a computer simulation, a very detailed and accurate assignment code can be established. It is also possible to limit the computer simulation to certain pairs of variates and to establish the assignment code through interpolation between these values.

Alternatively to a computer simulation beforehand, the assignment can also be performed through a computer based calculation during the plant operation. In this case it is provided that the preset assignment code is stored in the form of a computer program, which analyses the measured values for the acceleration a and the wind velocity v during the operation of the wind energy plant. Thus, there is a continuous analysis of the measured values of acceleration and wind velocity in “real time”, in order to establish the characteristic value for the strain.

According to one embodiment, the preset assignment code is established or verified by the analysis of measured strain values. For instance, wire strain gauges can be used to measure and log the actually occurred strains under different operating conditions. On the basis of the logged measured values, an assignment code can be defined, which is characteristic for the respective type of plant or the individual plant. An analysis of corresponding measured strain values may also serve for verifying a assignment code preset on the basis of a computer simulation.

In one embodiment, the assignment code depends on at least one further parameter, which describes an operational state or an operational condition of the wind energy plant. The further parameter characterises a variable which influences the strain which is to be established. For instance, the same may be a blade pitch of a rotor blade, a generator or rotor torque, the electric power generated by the generator or an external condition, like the environmental temperature, the air pressure or the air humidity, for instance. Taking into account such a parameter in the assignment code permits an even more accurate establishment of the strain.

The wind energy plant according to the present invention has means for measuring a wind velocity v, means for measuring an acceleration a of a component of the wind energy plant, and a data processing unit, which has an entry which is connected to the means for measuring the wind velocity v and an entry which is connected to the means for measuring the acceleration a, and by which a value representing the measured wind velocity v and a value representing the measured acceleration a can be established, and which can assign a characteristic value for a strain of the wind energy plant to the pair of variates of the value for the wind velocity v and the value for the acceleration a, and which can make the characteristic value available for a subsequent analysis, wherein an assignment code is stored in the data processing unit, which assigns a characteristic value for a strain of the wind energy plant to each pair of variates of a value for a wind velocity and a value for an acceleration of a component of the wind energy plant.

Through the data processing unit with the assignment code stored therein, the wind energy plant is particularly suited to perform the method according to claim 1. In this, the data processing unit can be a constituent of a central control unit, like a control computer for instance. The assignment code stored therein can be stored in suitable memory areas or on a data carrier, for instance. The data processing unit can establish a strain of the wind energy plant on the basis of the measured data for the wind velocity v and the acceleration a and it can make a characteristic value representing this strain available for a subsequent analysis. In this, the subsequent analysis can immediately retroact on the operation management of the wind energy plant as well as be a long-term analysis independent of the immediate operation.

According to one embodiment, the means for measuring the acceleration a have at least one acceleration sensor, which is arranged in the region of the tower head of the wind energy plant. In principle, accelerations of arbitrary components can be analysed, for instance by placing an acceleration sensor into a rotor blade of a wind energy plant. However, the analysis is preferably related to the acceleration of the tower head, in order to establish a strain of the tower of the wind energy plant.

According to one embodiment, one of the acceleration sensors is a torsional acceleration sensor, which is arranged in the region of the tower head of the wind energy plant. Thus, a torsional movement can also be acquired.

As was already explained for the corresponding embodiments of the method of the present invention, the characteristic value can be a numerical value, which quantitatively indicates the strain of the component of the wind energy plant, or the characteristic value can take on only two different values, wherein a first value indicates a permissible strain and a second value a not permissible strain of the component of the wind energy plant.

In one embodiment, the wind energy plant has an operation management with a control for the operation of the wind energy plant, and the data processing unit can preset a desired value for the operation of the wind energy plant on the basis of the characteristic value for the strain, wherein the control has an entry for the desired value. With the desired value, it can be matter of a power, a rotational speed or a torque, for instance.

### BRIEF DESCRIPTION OF THE SEVERAL VIEWS OF THE INVENTION

In one embodiment, the wind energy plant can perform the method according to any one of the claims 1 to 12. In this, the execution of the method can be permitted in particular through a corresponding realisation of a program of the data processing unit. The method is explained in more detail in the following by means of examples of its realisation, depicted in figures.

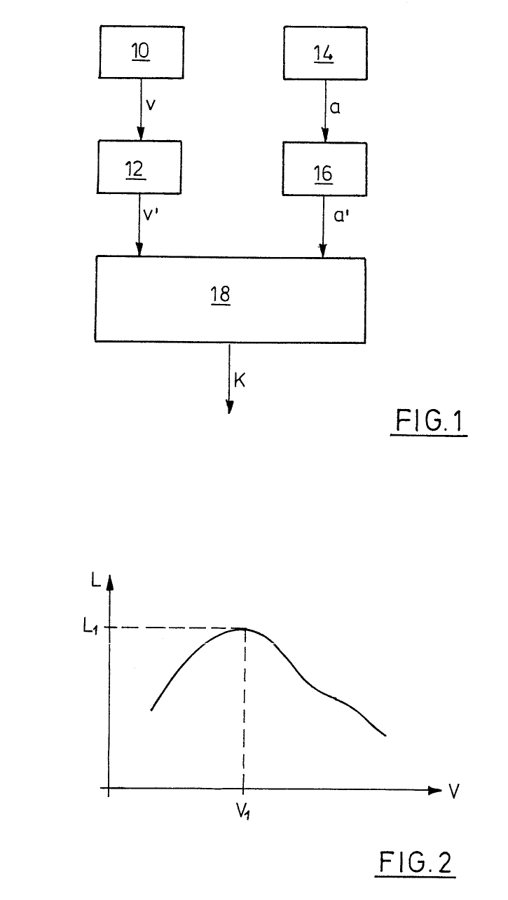

FIG. 1 shows a block diagram concerning the method of the present invention;

FIG. 2 shows a diagram concerning the dependence of a strain from a wind velocity;

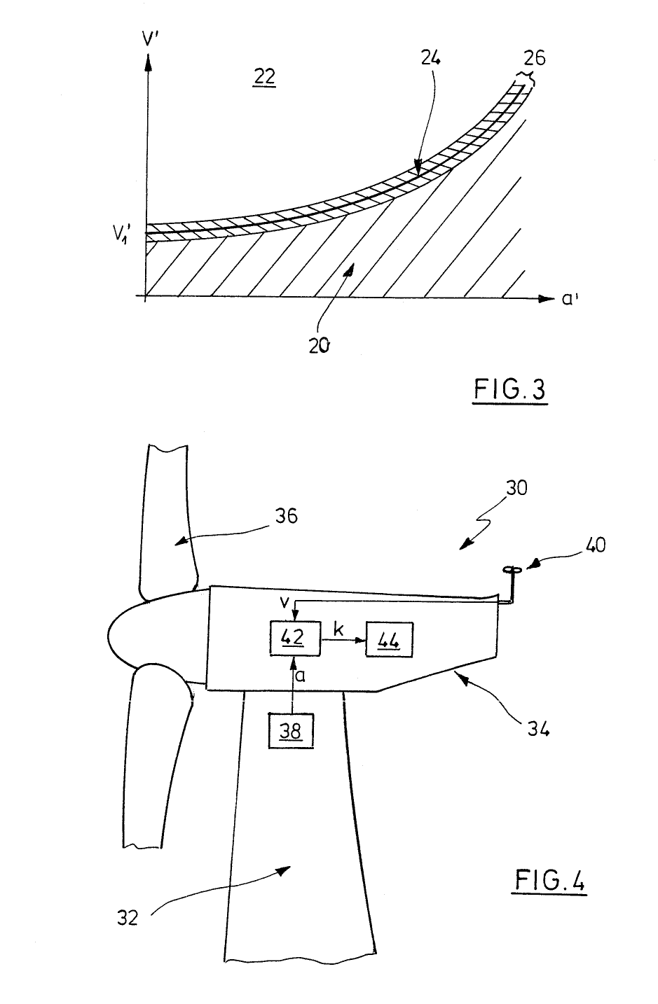

FIG. 3 shows a diagram of an assignment code, which assigns one characteristic value to each pair of variates for an acceleration and a velocity;

FIG. 4 shows a simplified schematic depiction of a wind energy plant, which can execute the method of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

The block diagram depicted in FIG. 1 shows the essential steps of the method of the present invention. In a first step, illustrated by the block 10, there is a continuous measurement of the wind velocity v. As indicated by the arrow, the measured value for the wind velocity v is forwarded to the block 12, where a value v′ is established, which represents the measured wind velocity. In the depicted example of realisation, an averaging of the amount of the measured wind velocity v for a preset time interval takes place in the block 12 for this purpose. In the block 14, a continuous measurement of an acceleration a of a component of the wind energy plant takes place. The measured value for the acceleration is forwarded to the block 16, as is indicated by the arrow. In the block 16, a value a′ is established, which is determined by averaging the amounts of the measured acceleration a for a preset time interval. The two values v′ and a′ representing the respective measured variables are supplied into the block 18 as input variables. In the block 18, an assignment code is stored, which assigns a characteristic value K for the strain of the wind energy plant to each pair, of variates of a value v′ for a wind velocity and a value a′ for an acceleration of a component of the wind energy plant. Block 18 makes the characteristic value K available for a subsequent analysis. The characteristic value K indicates a strain of the component of the wind energy plant.

In FIG. 2 it is shown in an exemplary manner how a strain L of a component of a wind energy plant depends on a wind velocity v. It comes out that the relation between the strain L and the wind velocity v is complicated. At a certain wind velocity v₁, the strain L reaches a maximum value L₁. When the wind velocity v increases further to above the value v₁, the strain L of the component of the wind energy plant surprisingly decreases. Such a relation exists for the strain of the tower of a wind energy plant, for instance, when a desired value, for instance that for the power generated by the wind energy plant, is reached in the operation of the wind energy plant at a wind velocity v₁, and the thrust exerted by the rotor on the tower of a wind energy plant decreases through the variation of the pitch angle at further increasing wind velocities. The example makes clear that the actually occurring strains depend on different parameters of the operation of the wind energy plant in a complicated manner. In particular, turbulences play an important role, which cannot acquired by a measurement of the wind velocity alone. Even based on a measurement of an acceleration, which reflects a dynamic strain through a vibrational movement of a corresponding component of the wind energy plant in particular, no reliable statement about the actually occurring strain of the component can be established as well.

Therefore, a measured acceleration as well as a measured wind velocity is analysed in the invention. In FIG. 3 it is shown how the assignment code from block 18 of FIG. 1 assigns a characteristic value for the strain to each pair of variates of a value a′ for the measured acceleration and a value v′ for the measured wind velocity. In the example of FIG. 3, the two-parameter value range of the assignment code is depicted in the plane of projection. The values a′ for the acceleration are found on the horizontal axis, the values v′ for the wind velocity are plotted on the vertical axis. With the aid of a computer simulation, one strain is assigned to each pair of variates a′, v′. By setting an upper limit for this strain, a curve 24 is obtained, which in the depicted value range divides pairs of variates of a range 22, to which still permissible strains of the observed component of the wind energy plant are assigned, from a value range 20 in which there are pairs of variates which lead to a not permissible strain of the observed components of the wind energy plant. The two value ranges 20 and 22 are divided from each other through the course of the curve 24. The curve 24 is surrounded by a tolerance range 26, in which the occurring strains are in a boundary region between permissible and not permissible values. For instance, it can be provided to regard pairs of variates from the tolerance range 26 as being permissible for a certain, preset period of time.

Thus, in the example of FIG. 3, the illustrated assignment code assigns one of three possible characteristic values K to each pair of variates a′, v′. The values which the characteristic value K can adopt, are “permissible”, “not permissible” and “in the tolerance range”. Alternatively, the assignment code can assign only two values, “permissible” and “not permissible” to each pair of variates a′, v′, or a numerical value which quantitatively indicates the strain of the observed component.

A wind energy plant of the present invention is depicted in FIG. 4 in a simplified manner. The wind energy plant 30 has a tower 32, the upper end of which is sketched out in the figure. The tower carries a nacelle 34, on which a rotor with rotor blades 36 is fixed. In the region of the head of the tower 32, acceleration sensors 38 are arranged, which supply a measured value for the acceleration a of the tower head. A wind measuring device 40 is arranged on the upper rear end of the nacelle 34 and it supplies a measured value for the wind velocity v. The measured values for the acceleration a and the wind velocity v are forwarded to a data processing unit 42, which based on the measured values establishes a characteristic value K for a strain of the wind energy plant tower in the manner described in FIG. 1. The characteristic value K is made available on an output of the data processing unit 42 and is forwarded to an operation management 44 in the depicted example. Based on the characteristic value K, a desired value for the operation of the wind energy plant is determined and used by the operation management 44 for the control of the operation of the wind energy plant.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manner's within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for the determination of a strain of a wind energy plant (30), with the following steps: presetting an assignment code, which assigns a characteristic value (K) for the strain of the wind energy plant to each pair of variates of a value for a wind velocity and a value for an acceleration of a component of the wind energy plant, determining a value (v′), which represents a measured wind velocity v, determining a value (a′), which represents a measured acceleration a of a component of the wind energy plant, applying the assignment code to the pair of variates of the value (v′) for the measured wind velocity v and the value (a′) for the measured acceleration a in order to determine the characteristic value (K) for the strain.

2. A method according to claim 1, characterised in that the value (v′), which represents the measured wind velocity v and/or the value (a′), which represents the measured acceleration a, is established by generating an average value of the respective measured variable (a, v) about a preset time interval.

3. A method according to claim 1, characterised in that the value (v′), which represents the measured wind velocity v and/or the value (a′), which represents the respective measured acceleration a, is established by calculating a standard deviation of the respective measured variable (a, v) about a preset time interval.

4. A method according to claim 2, characterised in that for the average value generation and/or for the calculation of the standard deviation of the measured wind velocity v, a longer or shorter time interval is preset than for the average value generation or for the calculation of the standard deviation, respectively, of the measured acceleration a.

5. A method according to any claim 1, characterised in that the measurement of the acceleration a takes place with one or more acceleration sensors (38), which are arranged in the region of the tower head of the wind energy plant (30).

6. A method according to claim 1, characterised in that in the establishment of the value (a′), which represents an acceleration a, it is averaged about different space directions of the acceleration.

7. A method according to claim 1, characterised in that an acceleration sensor (38) measures a torsional acceleration in the region of the tower head of the wind energy plant (30).

8. A method according to claim 1 characterised in that the characteristic value (K) is a numerical value which quantitatively indicates the strain of the component of the wind energy plant.

9. A method according to a claim 1, characterised in that the characteristic value (K) takes on only two different values, wherein a first value indicates a permissible strain and a second value a not permissible strain of the component of the wind energy plant.

10. A method according to claim 1, characterised in that an analysis of the established characteristic values (K) takes place about long periods of time, in order to detect a material fatigue.

11. A method according to claim 1, characterised in that an established characteristic value (K) is analysed in the operation of the wind energy plant, in order to preset a desired value for the operation of the wind energy plant.

12. A method according to claim 1, characterised in that the preset assignment code is established with the aid of a computer simulation, which takes into account the mechanical and aerodynamical properties of the wind energy plant (30).

13. A method according to claim 1, characterised in that the preset assignment code is stored in the form of a computer program, which analyses the measured values for the acceleration (a) and the wind velocity v during the operation of the wind energy plant.

14. A method according to claim 1, characterised in that the preset assignment code is established or verified by the analysis of measured strain values.

15. A method according to claim 1, characterised in that the assignment code depends on at least one further parameter, which describes an operational state or an operational condition of the wind energy plant.

16. A wind energy plant (30), with a device (40) for measuring a wind velocity v, a sensor (38) for measuring an acceleration a of a component of the wind energy plant (30), and a data processing unit (42), which has an entry which is connected to the device for measuring the wind velocity v and an entry which is connected to the device for measuring the acceleration a, and by which a value (v′) representing the measured wind velocity v and a value (a′) representing the measured acceleration a can be established, and which can assign a characteristic value (K) for a strain of the wind energy plant to the pair of variates of the value (v′) for the wind velocity v and the value (a′) for the acceleration a, and which can make the characteristic value (K) available for a subsequent analysis, wherein an assignment code is stored in the data processing unit (42), which assigns a characteristic value (K) for a strain of the wind energy plant (30) to each pair of variates of a value (v′) for a wind velocity and a value (a′) for an acceleration of a component of the wind energy plant.

17. A wind energy plant (30) according to claim 16, characterised in that the data processing unit (42) has an equipment for the generation of an average value of the measured wind velocity v and/or of the measured acceleration a about a preset time interval.

18. A wind energy plant (30) according to claim 16, characterised in that the data processing unit (42) has an equipment for the calculation of the standard deviation of the measured wind velocity v and/or of the measured acceleration a in a preset time interval.

19. A wind energy plant (30) according to claim 16, characterised in that the means (38) for measuring the acceleration a have at least one acceleration sensor (38), which is arranged in the region of the tower head of the wind energy plant (30).

20. A wind energy plant (30) according to claim 19, characterised in that one of the acceleration sensors (38) is a torsional acceleration sensor, which is arranged in the region of the tower head of the wind energy plant (30).

21. A wind energy plant (30) according to claim 16, characterised in that the characteristic value (K), which can be made available by the data processing unit (42), is a numerical value which quantitatively indicates the strain of the component of the wind energy plant (30).

22. A wind energy plant (30) according to claim 16, characterised in that the characteristic value (K), which can be made available by the data processing unit (42), can take on only two different values, wherein a first value indicates a permissible strain and a second value a not permissible strain of the wind energy plant.

23. A wind energy plant (30) according to claim 16, characterised in that the wind energy plant (30) has an operation management (44) with a control for the operation of the wind energy plant (30), and the data processing unit can preset a desired value for the operation of the wind energy plant (30) on the basis of the characteristic value (K) for the strain, wherein the control has an entry for the desired value.
